(19) United States
(12) Patent Application Publication
(10) Pub. No.: US 2019/0232424 A1
(43) Pub. Date: Aug. 1, 2019

(54) HYBRID WELD JOINT AND METHOD OF FORMING THE SAME

(71) Applicant: Shiloh Industries, Inc., Valley City, OH (US)

(72) Inventors: James W. Walther, Chatam, OH (US); John R. Ewolski, Brunswick, OH (US); Clifford J. Hoschouer, Medina, OH (US); Anthony Santamaria, North Ridgeville, OH (US)

(21) Appl. No.: 16/320,370

(22) PCT Filed: Aug. 3, 2017
(86) PCT No.: PCT/US2017/045374

§ 371 Date: Jan. 24, 2019

Related U.S. Application Data
(60) Provisional application No. 62/370,528, filed on Aug. 3, 2016.

(51) Int. Cl. B23K 26/244; B23K 26/24; B23K 26/242; B23K 26/26; B23K 26/323

(52) U.S. Cl. CPC B23K 26/244; B23K 26/24; B23K 2101/006; B23K 26/26; B23K 26/323; B23K 26/242

(57) ABSTRACT

A hybrid weld joint for joining sheet metal pieces together. According to one example, the hybrid weld joint exhibits characteristics of both butt welds and lap joints and is used to create a tailor-welded blank assembly where at least one sheet metal piece is made of aluminum or an aluminum-based alloy. Such a tailor-welded blank assembly is particularly suitable for the automotive industry.

### TECHNICAL FIELD

The present disclosure generally relates to weld joint configurations and, more specifically, to a hybrid weld joint configurations that are used to join sheet metal pieces together where at least one of the pieces is aluminum or an aluminum-based alloy.

### BACKGROUND

Conventional butt welding of aluminum and aluminum-based alloys can present challenges because of the relatively low liquid phase viscosity of aluminum, which can cause the molten aluminum material to leak or drip out from between the abutted edges during welding. This is particularly true as the weld joint formation proceeds all the way through the thickness of the aluminum sheet edges and approaches the opposite side. One potential solution to this problem is to separately form the weld joint from both sides of the aluminum pieces, which requires either dual laser beams or inverting the work pieces after forming the first partial weld joint. However, such a solution adds cost and complexity to the manufacturing process.

Conventional lap welding, on the other hand, usually results in welded blank assemblies having stepped sides, but no flush or smooth sides. Skilled artisans will appreciate that welded blank assemblies with flush or smooth sides enable use in a variety of applications, such as automotive applications like door inners, where non-flush or stepped joints may not be permitted.

Thus, there may be a need to develop welds and welding techniques that utilize some of the benefits of both butt and lap welding and that are suitable for use with aluminum or aluminum-based alloys.

### SUMMARY

According to one aspect, there is provided a welded blank assembly, comprising: a first sheet metal piece having an end with a reduced thickness portion and a recess; a second sheet metal piece having an end that nests within the first sheet metal piece recess; and a hybrid weld joint joining the first and second sheet metal pieces together, wherein the hybrid weld joint includes both a lap portion and a butt portion.

According to another aspect, there is provided a method of making a welded blank assembly. The method may comprise the steps of: providing a first sheet metal piece having an end with a reduced thickness portion and a recess; providing a second sheet metal piece having an end, wherein the first sheet metal piece, the second sheet metal piece, or both the first and second sheet metal pieces is made of aluminum or an aluminum-based alloy; arranging the first and second sheet metal pieces so that the second sheet metal piece end nests within the first sheet metal piece recess; and using a laser to form a hybrid weld joint between the first and second sheet metal pieces, wherein the hybrid weld joint includes both a lap portion and a butt portion.

### DRAWINGS

Preferred exemplary embodiments of the invention will hereinafter be described in conjunction with the appended drawings, wherein like designations denote like elements, and wherein:

FIGS. 1A-1C illustrate formation of embodiments of a hybrid weld joint that join dissimilar gauge material and are welded from a flush side of the assembly;

FIGS. 2A-2D illustrate formation of other embodiments of a hybrid weld joint that join dissimilar gauge material and are welded from a stepped side of the assembly;

FIGS. 3A-3C illustrate formation of other embodiments of a hybrid weld joint that join similar gauge material; and

FIGS. 4A-4C illustrate formation of another embodiment of a hybrid weld joint that joins dissimilar gauge material and is welded from a flush side of the assembly.

### DETAILED DESCRIPTION

As described below, a hybrid weld joint can be used to join sheet metal pieces together in a manner that enjoys the advantages of both conventional butt welds and conventional lap joints, while overcoming certain disadvantages associated with conventional welding. The hybrid weld joint described herein is particularly useful in the manufacture of tailor-welded blank assemblies, in which two sheet metal pieces have some characteristic difference from each other, such as dissimilar gauges, different metal compositions or microstructures, different coating types, etc. According to one example, the hybrid weld joint described herein exhibits characteristics of both butt welds and lap joints and is used to create a tailor-welded blank assembly where at least one sheet metal piece is made of aluminum or an aluminum-based alloy. Moreover, the hybrid weld joint allows the tailor-welded blank to be welded from only one side, which can be an advantage when welding sheet metal pieces made of aluminum or aluminum-based alloys.

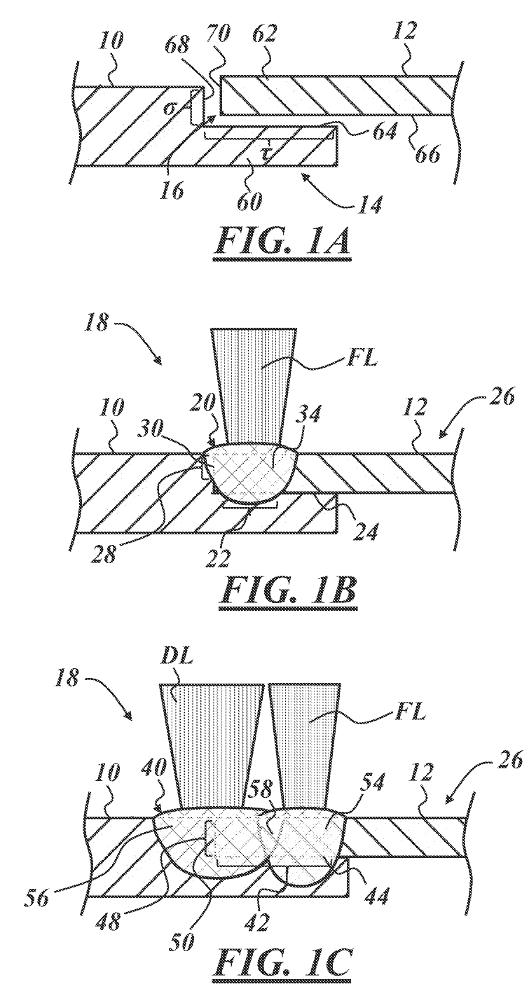

FIGS. 1A-1C schematically illustrate two different methods for forming a welded blank assembly having sheet metal pieces with dissimilar gauges or thicknesses, where a hybrid weld joint is formed on a flush side of the assembly. The method generally includes providing a first sheet metal piece 10 and a second sheet metal piece 12, at least one of which includes a reduced thickness portion 14 and a corresponding recess 16. The reduced thickness portion 14 preferably has a size and shape that is developed for the particular application in which the welded blank assembly is used. According to one embodiment, the recess 16 has a length τ that is between 2 mm and 5 mm, inclusive, and a depth σ that is between 0.25 mm and 2 mm, inclusive. In a specific embodiment where the first sheet metal piece 10 is aluminum or an aluminum-based alloy (e.g., Al 5182) and has a thickness of 1 mm to 3 mm, inclusive, the length τ is between 2 mm and 5 mm, inclusive, and the depth σ that is between 1 mm and 1.5 mm, inclusive. In an example where the first sheet metal piece 10 is made of steel and has a thickness of 1 mm to 3 mm, inclusive, the length τ is between 2 mm and 5 mm, inclusive, and the depth σ that is between 0.7 mm and 1.2 mm, inclusive. Of course, these are just non-limiting exemplary dimensions, as the actual dimensions of the hybrid weld joint could vary. The reduced thickness portion 14, and consequently the recess 16, may be created by machining, grinding, coining or some other suitable process and is preferably formed in the thicker of the two sheet metal pieces. Skilled artisans will appreciate that certain operations, such as coining where the edge of a sheet metal piece is stamped under sufficiently high stress so that the reduced thickness portion 14 is created, can result in changes to the sheet metal microstructure and/or the sheet metal properties (e.g., hardness, ductility, etc.) that may or may not be desirable. Machining, on the other hand, typically does not affect or change the microstructure or properties of the sheet metal piece in a significant way. This too may or may not be desirable, depending on the particular application. Other methods and techniques for forming the reduced thickness portion 14 and/or the recess 16 may also be used.

With the sheet metal pieces 10, 12 clamped or otherwise secured in place, one or more laser beams are directed at an overlapping area so that a hybrid weld joint can be created that attaches the first and second sheet metal pieces together and forms the welded blank assembly 18. In FIG. 1B, a single focused laser FL on a flush side 26 of the assembly 18 is used to form a hybrid weld joint 20 that includes a keyhole weld that at least partially encompasses lap and butt portions of the hybrid weld joint. In FIG. 1C, a focused laser FL and a defocused laser DL, both of which impinge the assembly 18 on the flush side 26, are used to form a hybrid weld joint 40 that includes both a keyhole weld that encompasses a lap portion of the weld joint and a conduction weld that encompasses a butt portion of the weld joint. Dashed lines are superimposed on the hybrid weld joint to illustrate the original locations and perimeters of adjacent surfaces of the respective sheet metal pieces 10, 12 before the weld joint was formed.

The resulting weld joint may be considered a hybrid weld joint because it includes both a lap portion and a butt portion. To explain, a lap portion (item 22 in FIG. 1B and item 42 in FIG. 1C) is formed in the weld where the sheet metal pieces 10, 12 overlap in a sort of stacked or layered arrangement. For example, an end 62 of the second sheet metal piece 12 overlaps and nests within the recess 16 formed by the reduced thickness portion 14 of the first sheet metal piece 10, the reduced thickness portion being located at an end 60 of the first sheet metal piece. Once formed, a weld joint or weldment extends across a lap interface 24, 44; more specifically, the weld extends across a lap interface 24, 44 where horizontal surfaces 64, 66 of the ends 60, 62 oppose and contact one another. In terms of a butt portion (item 28 in FIG. 1B and item 48 in FIG. 1C), a weld joint or weldment encompasses or covers a portion of a butt interface 30, 50 that exists where vertical surfaces or edges 68, 70 of the sheet metal ends 60, 62 oppose and contact one another; that is, where they butt up against one another. The lap portions 22, 42 exist in the weld at the lap interfaces 24, 44, respectively, and the butt portions 28, 48 exist in the weld at the butt interfaces 30, 50, respectively. In this particular example, the vertical surface 68 is an interior edge that only partially extends through the thickness of the first sheet metal piece 10 (i.e., it forms a step), whereas the vertical surface 70 is an exterior edge that extends through the entire thickness of the second sheet metal piece 12.

The hybrid weld joint may be formed using focused and/or defocused laser welding techniques, as illustrated in FIGS. 1B and 1C. Focused laser welding techniques, like keyhole or fiber laser welding, are characterized by relatively high laser beam energy density and typically result in relatively small or condensed laser spots that create more vaporization of metal during joint formation. Defocused laser welding techniques, such as conduction welding, are characterized by lower laser beam energy density and typically result in relatively large or defocused laser spots and create less vaporization of metal during joint formation. Welds produced by focused laser welding, such as keyhole welds, are sometimes preferable due to a faster processing speed and/or a smaller heat-affected zone along the weld joint. But material vaporization can aggravate the issue of material loss that is sometimes present in a conventional butt weld, as material loss at the abutted surfaces can result in a weaker joint. Conventional butt welding, especially with metals having a relative low liquid phase viscosity, is often limited to slower conduction welding and a larger heat affected zone, which can affect material properties away from the weld joint.

In the embodiment of FIG. 1B, where a single focused laser FL is used to create a hybrid weld joint 20, the welding can be performed according to a focused laser welding technique so as to create a keyhole weld 34 that penetrates all the way through the end 62 of sheet metal piece 12 and at least partially into the end 60 of sheet metal piece 10; in this way, the keyhole weld 34 penetrates and extends across the lap interface 24 and helps form the lap portion 22. Some material loss due to vaporization may occur, but will likely not adversely affect weld strength because the material loss will primarily be within the thickness of the top one of the overlapped pieces—i.e., the material loss will be within the stacked section of the sheet metal pieces. According to the embodiment of FIG. 1C, a first focused laser welding technique provides a focused laser beam FL which creates a keyhole weld 54 that penetrates completely through the sheet metal piece 12 and at least partially into the sheet metal piece 10, and a second defocused laser welding technique uses a defocused laser DL that creates a conduction weld 56 that spans the butt interface 50 and helps create the butt portion 48. The keyhole weld 54 and the conduction weld 56, which may or may not connect or overlap with one another, together help form the hybrid weld joint 40. In the particular embodiment of FIG. 1C, the keyhole weld 54 and the conduction weld 56 connect at an overlapped weld joint section 58.

As mentioned above, the resulting hybrid weld joint has a configuration that may be able to enjoy certain advantages typically associated with conventional butt welded as well as lap welded blank assemblies. For example, on at least one of the sides of the finished welded blank assembly 18, the first and second sheet metal pieces 10, 12 are flush with one another; this characteristic is oftentimes associated with butt welded assemblies, but not lap welded assemblies. Skilled artisans will appreciate that welded blank assemblies with flush or smooth sides enable use in a variety of applications, such as automotive applications like door inners, where non-flush or stepped joints may not be permitted. In the examples of FIGS. 1B-1C, the upper surfaces of the first and second sheet metal pieces 10, 12 are flush at the side of the blank assembly 18 where the hybrid weld joint is formed. As used herein, surfaces of the first and second sheet metal pieces 10, 12 are considered “flush” when they both lie along a coextensive contour or surface of the blank assembly 18; it is not required that the surfaces be flat or planar, as shown in this example, as they may be three-dimensional or contoured and still be flush. Moreover, it is not necessary that the respective surfaces be perfectly coextensive in order to be “flush,” within the meaning of that word, as it is used herein. Some variation due to manufacturing tolerances, weld joint protrusion (i.e., the convex part of the weld joint that extends above the sheet metal surfaces), etc. should be allowed and can still constitute “flush” surfaces.

Another potential benefit of the hybrid weld joint described herein pertains to its suitability in welding aluminum or aluminum-based alloys. Skilled artisans will appreciate that welding aluminum-based materials can be difficult due to their low liquid phase viscosity, as well as other thermal properties like their coefficient of thermal expansion and thermal conductivity. To illustrate, conventional butt welding of aluminum and aluminum-based alloys presents challenges because of the relatively low liquid phase viscosity of aluminum, which can cause the molten aluminum material to leak or drip out from between the abutted edges during welding. This is particularly true as the weld joint formation proceeds all the way through the thickness of the aluminum sheet edges and approaches the opposite side. One potential solution to this problem is to separately form the weld joint from both sides of the aluminum pieces—that is, a partial weld joint is formed from one side and then a second partial weld joint is formed from the other side, requiring either dual laser beams or inverting the work pieces after forming the first partial weld joint. Because of the configuration of the hybrid weld joint described herein, which does not include a traditional butt weld extending all the way through the sheet metal pieces, such measures may be avoided.

Another potential advantage of the present hybrid weld joint pertains to its manufacturability. For instance, conventional butt welding operations, particularly those utilizing focused lasers with relatively small laser spots, must be very accurate in terms of precisely directing the laser to the butt interface where the two vertical surfaces abut one another. If the laser guidance is off, even by a small amount, the small laser spot may not adequately cover the butt interface, which could result in an unwelded section. The hybrid weld joint 40 shown in FIG. 1C, for example, addresses this challenge by utilizing a wider defocused laser DL to cover the vertical seam or butt interface 50 (this enables somewhat greater leeway in terms of the laser guidance or positioning). Because of the lower energy density of the defocused laser DL, the resulting conduction weld 56 may not penetrate as deeply as other welds, however, the hybrid weld joint 40 makes up for this with the keyhole weld 54 formed at the lap portion 42. The exact lateral positioning of the focused laser beam FL and, hence, the keyhole weld 54 may not be as critical at the lap portion 42 as it is at the butt portion 48, so long as they cover a sufficient section of the lap interface 44. By using a defocused laser DL to create a wider and shallower conduction weld 56 at the butt interface 50 and a focused laser FL to create a narrower and deeper keyhole weld 54 at the lap interface 44, the hybrid weld joint 40 is able to enjoy many benefits of both butt and lap welded assemblies. In addition, the horizontal surfaces 64, 66 at the lap interface may not need to be as smooth or flat as the interfacing surfaces of a conventional lap weld in order to form a weld joint of sufficient strength, nor do the vertical surfaces 68, 70 at the butt interface need to be as close together as in a traditional butt joint.

Another possible benefit of the present hybrid weld joint pertains to its strength and integrity. The overall length of the hybrid weld joint interface is the sum of the lengths of the butt interface 30, 50 and the lap interface 24, 44. For example, the overall length of the hybrid weld joint interface for the embodiment of FIG. 1B is the sum of the butt interface 30 and the lap interface 24, whereas the overall length of the hybrid weld joint interface for the FIG. 1C embodiment is the sum of butt interface 50 and the lap interface 44. Because the hybrid weld joint has a larger joint interface than that of a conventional butt weld or lap weld individually, the strength of the weld can oftentimes be greater. According to a non-limiting example of a welded blank assembly 18 where at least one of the sheet metal pieces is made from aluminum or an aluminum-based alloy, the butt interface 30, 50 may have a length of between 1 mm to 1.5 mm, inclusive, and the lap interface 24, 44 may have a length of between 2 mm to 5 mm, inclusive, which results in an overall length of the hybrid weld joint interface of between 3 mm to 6.5 mm, inclusive. Typically, the more interface surface area the stronger the weld joint.

The hybrid weld joint may possess combinations of advantages and benefits, other than the exemplary ones cited herein. For instance, the present hybrid weld joint may include: improved weld quality due to decreased porosity and pin holes because of the outgassing channel that will be created when the two sheet metal pieces 10, 12 are pushed together; lower shear to break during subsequent metal forming operations; elimination of the need for tracking a seam line during welding of the lap portion; an increase in weld speed; avoiding having to weld aluminum-based sheet metal pieces from both sides; and/or the ability to weld similar gauge material without the need for filler wire, to cite a few possibilities.

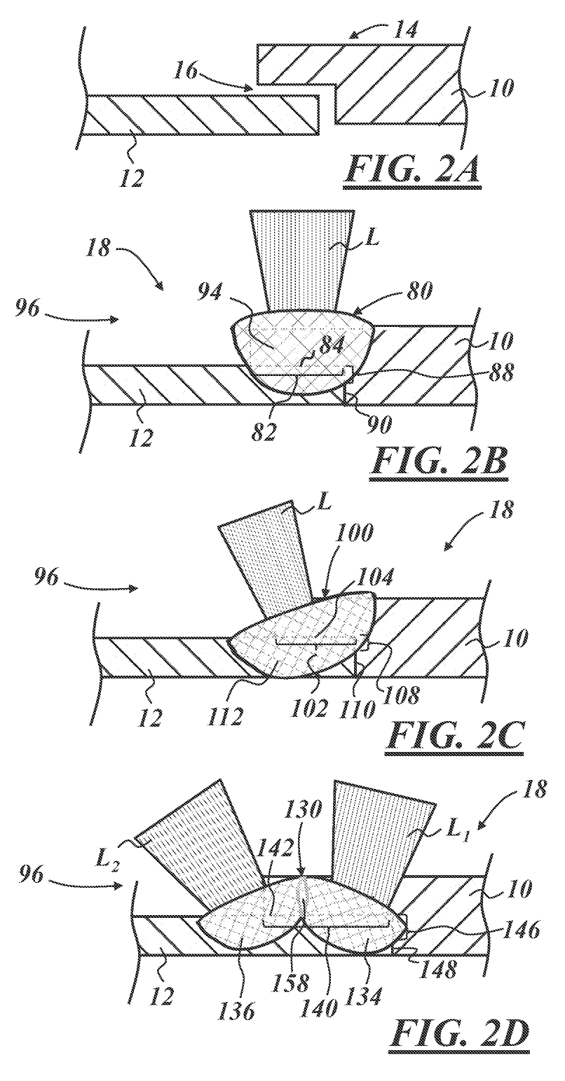

Turning now to the embodiments of FIGS. 2A-2D, there is again shown a first sheet metal piece 10 with a reduced thickness portion 14 and recess 16 and a second sheet metal piece 12 of a dissimilar gauge, as before, except that in these embodiments the hybrid weld joint is formed at the non-flush or stepped side of the assembly. The description provided above in conjunction with FIGS. 1A-1C apply to the embodiments of FIGS. 2A-2D, except for where it is noted below.

Starting with FIG. 2B, a single laser L is used to create a hybrid weld joint 80 on a stepped side of the assembly that includes both a lap portion 82 at a lap interface 84 and a butt portion 88 at a butt interface 90. The laser could be a focused or defocused laser, and in one particular embodiment, the laser is a focused laser so that a keyhole weld 94 is formed. FIG. 2B shows the laser L impinging or striking a top surface of the first sheet metal piece 10 at roughly a 90° angle, however, the angle of incidence of the laser L could be adjusted to accommodate the particular application. In this particular embodiment, the depth of the keyhole weld 94 is sufficient to penetrate completely through the reduced thickness portion 14, cross the lap interface 84, and extend into the second sheet metal piece 12. Furthermore, the width of the keyhole weld 94 is wide enough to span and at least partially cover the butt interface 90. Other configurations are certainly possible.

The embodiment in FIG. 2C is similar to that of FIG. 2B, except that the laser L impinges or strikes the stepped interface between the first and second sheet metal pieces 10, 12 and is oriented at a non-90° angle. In this case, a hybrid weld joint 100 is formed and has a lap portion 102 at a lap interface 104 and a butt portion 108 at a butt interface 110. Again, the laser L could be a focused or defocused laser, depending on the application. According to one exemplary embodiment, the laser is a defocused laser that creates a conduction weld 112 that covers at least a portion of both the lap interface 104 and the butt interface 110. Because of where the laser L strikes the work pieces, it is not necessary for the weld to penetrate all the way through the thickness of portion 14, as in the previous embodiment, although this is certainly possible. For this reason, it may be preferable to use a defocused laser that has a wider laser spot so as to more easily cover the interface between the two pieces and to avoid the necessity for more expensive laser positioning equipment and tools. Again, other configurations are possible.

FIG. 2D shows another embodiment where multiple lasers are used to create a hybrid weld joint 130 with different weldment portions. In this example, a first laser L₁ can be a focused or defocused laser and strikes an upper surface of the sheet metal piece 10, whereas a second laser L₂, which can also be focused or defocused, strikes the stepped junction or edge between the sheet metal pieces 10, 12. According to one potential implementation of this embodiment, laser L₁ is a focused laser and creates a somewhat deeper yet narrower keyhole weld 134 and laser L₂ is a defocused laser that forms a somewhat shallower and wider conduction weld 136. The combination of these two welds helps form the hybrid weld joint 130, which further includes a lap portion 140 at a lap interface 142 and a butt portion 146 at a butt interface 148. The exact depth and width of portions 140, 146 can vary depending on the application, the materials of the sheet metal pieces, the types of lasers used, etc. Depending on the nature of the hybrid weld joint, an overlapped weld joint section 158 may be present.

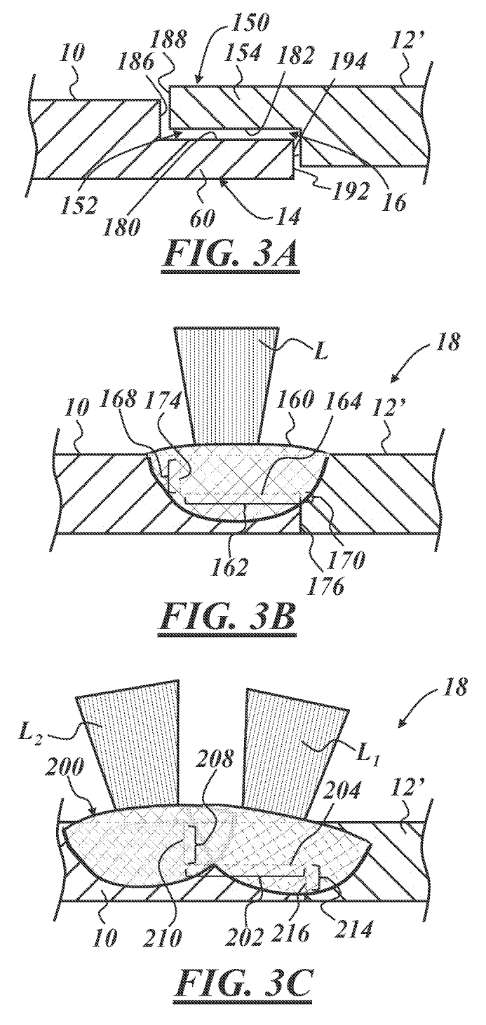

Turning now to FIGS. 3A-3C, several other embodiments of a hybrid weld joint are shown, where each embodiment involves welding two sheet metal pieces 10, 12′ of similar gauge or thickness. As illustrated in FIG. 3A, sheet metal piece 10 has a reduced thickness portion 14 and a correspondingly formed recess 16, as with previous embodiments, and sheet metal piece 12′ has a reduced thickness portion 150 and recess 152. The reduce thickness portions 14, 150 and recesses 16, 152 are designed to complement one another in terms of size and shape so that the ends 60, 154 of the sheet metal pieces can nest within each other. It is envisioned that one or both of the sheet metal pieces 10, 12′ is made from aluminum or an aluminum-based alloy.

In FIG. 3B, a single laser L is used to form a hybrid weld joint 160 that includes both lap and butt portions, as will be described. Once formed, the weld joint or weldment includes a lap portion 162 at a lap interface 164 and one or more butt portions 168, 170 located at one or more butt interfaces 174, 176. More specifically, the weld at the lap portion 162 extends across the lap interface 164, which is the junction or interface of horizontal surfaces 180, 182 of ends 60, 154, respectively. In terms of a first potential butt portion 168, the weld encompasses or covers a portion of a first butt interface 174 that exists where first vertical surfaces or edges 186, 188 of the sheet metal ends 60, 154 oppose and contact one another; that is, where they butt up against one another. A second potential butt portion 170 is formed where the weld encompasses or crosses a second butt interface 176, which is the junction of second vertical surfaces or edges 192, 194. As shown, it is not necessary for the first and/or second butt portions 168, 170 to encompass the fully extent of the butt interfaces 174, 176. In some embodiments, the hybrid weld joint 160 may only have one butt portion 168 or 170 and in other embodiments, the hybrid weld joint may have two butt portions 168 and 170. Laser L may be a focused or defocused laser, depending on the particulars of the application, including the gauge and composition of the sheet metal pieces 10, 12′.

FIG. 3C shows another example of a hybrid weld joint 200 that is formed with two lasers L₁ and L₂ and, like the previous embodiment, joins two sheet metal pieces 10, 12′ of the same gauge or thickness. The exact angle of incidence of the two lasers (i.e., the angle at which the lasers strike or impinge the upper surfaces of the sheet metal pieces) may vary depending on the application. Similarly, the selection of a focused or defocused laser for lasers L₁ and L₂ largely depends on the application and the types and thicknesses of sheet metal being used (e.g., steel versus aluminum). In the example of FIG. 3C, the hybrid weld joint 200 includes a lap portion 202 formed where the weld encompasses a lap interface 204, a first butt portion 208 formed where the weld encompasses a first butt interface 210, and a second butt portion 214 formed where the weld encompasses a second butt interface 216. Because the first butt interface 210 is located closer to the side of the assembly 18 where the lasers L₁ and L₂ form the weld, it may be preferable to use a defocused laser in laser L₁ to cover or track interface 110 since a wider laser spot may be more useful than a deeper weld, and to use a focused laser in laser L₂ since the laser must penetrate through the thickness of section 150 in order to get access to the second butt interface 216. Other arrangements are certainly possible.

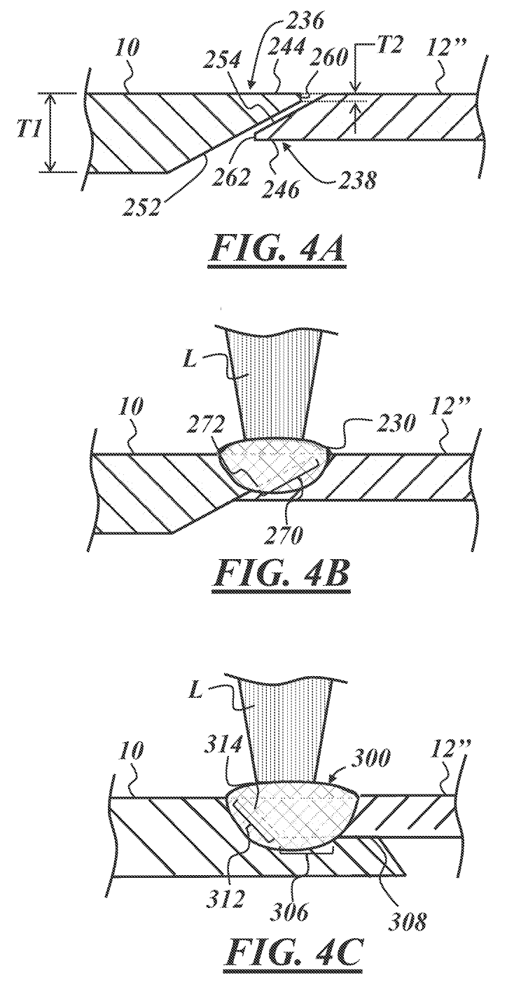

With reference now to the embodiment of FIGS. 4A-4C, there is shown an embodiment of a weld joint 230 that is formed between dissimilar gauge sheet metal pieces 10, 12″ that have tapered or angled edges instead of perpendicular ones, as in the previous embodiments. The first and second sheet metal pieces 10, 12″ include respective reduced thickness portions 236, 238 at respective ends 244, 246 that are formed by angled surfaces or edges 252, 254. In this example, each of the ends 244, 246 is beveled or tapered such that the sheet metal thickness is gradually reduced from a nominal thickness T1 to an edge thickness T2 at the respective vertical surfaces or edges 260, 262. In some embodiments, the edge thickness T2 of one or both of the pieces 10, 12″ can be essentially zero in the form of a sharp edge or edges (see FIG. 4B). Again, the use of a single laser L or multiple lasers, the use of focused or defocused lasers, as well as other parameters is largely governed by the particular application, materials, etc. In FIG. 4B, the weld joint 230 includes an angled lap portion 270 at an angled lap interface 272. It is possible in this embodiment for the weld to also encompass an upper and/or lower butt portion at butt interface involving surfaces 260 and/or 262, at which point the weld would be a hybrid weld. The greater the edge thickness T2, the greater the corresponding butt interface and butt portion.

The FIG. 4C embodiment includes tapered or angled edges, but has a somewhat different edge configuration than the previous embodiment. In this example, the hybrid weld joint 300 includes a lap portion 306 formed at a lap interface 308 and a butt portion 312 formed at a butt interface 314. Of course other configurations and arrangements are certainly possible.

Each of the hybrid weld joints in the above-described examples may be formed by: a single laser or multiple lasers (e.g., two or more lasers or a single laser with beam splitting); a laser that is perpendicular (i.e., a 90° angle of incidence) with respect to the sheet metal piece surfaces or a laser that is angled with respect to the sheet metal surfaces; a laser that strikes the sheet metal pieces from only one side of the assembly or one or more lasers that strike the sheet metal pieces from both sides of the assembly; a focused laser, a defocused laser or both; using sheet metal pieces made of steel, aluminum, aluminum-based alloys, some other metals, or a combination thereof, to cite just a few of the possibilities.

It is to be understood that the foregoing description is not a definition of the invention, but is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. A welded blank assembly, comprising:
a first sheet metal piece having an end with a reduced thickness portion and a recess;
a second sheet metal piece having an end that nests within the first sheet metal piece recess; and
a hybrid weld joint joining the first and second sheet metal pieces together, wherein the hybrid weld joint includes both a lap portion and a butt portion.

2. The welded blank assembly of claim 1, wherein the first sheet metal piece is made of aluminum or an aluminum-based alloy and has a thickness of 1 mm to 3 mm, inclusive, and the recess has a length τ that is between 2 mm and 5 mm, inclusive, and a depth σ that is between 1 mm and 1.5 mm, inclusive.

3. The welded blank assembly of claim 1, wherein the first sheet metal piece is made of steel and has a thickness of 1 mm to 3 mm, inclusive, and the recess has a length τ that is between 2 mm and 5 mm, inclusive, and a depth σ that is between 0.7 mm and 1.2 mm, inclusive.

4. The welded blank assembly of claim 1, wherein at least one of the first or second sheet metal pieces is made of aluminum or an aluminum-based alloy, the first and second sheet metal pieces have a dissimilar gauge, a surface of the first sheet metal piece is flush with respect to a surface of the second sheet metal piece at a flush side of the welded blank assembly, and the hybrid weld joint extends from the flush side into the welded blank assembly.

5. The welded blank assembly of claim 4, wherein the hybrid weld joint includes a keyhole weld that extends from the flush side into the welded blank assembly such that it penetrates all the way through the end of the second sheet metal piece, crosses a lap interface formed by opposing horizontal surfaces of the first and second sheet metal pieces, and at least partially extends into the end of the first sheet metal piece.

6. The welded blank assembly of claim 5, wherein the keyhole weld contributes to both a lap portion and a butt portion of the hybrid weld joint and the hybrid weld joint is formed using a single laser.

7. The welded blank assembly of claim 5, wherein the hybrid weld joint further includes a conduction weld that extends from the flush side into the welded blank assembly such that it spans a butt interface formed by opposing vertical surfaces of the first and second sheet metal pieces and at least partially extends into the end of the second sheet metal piece.

8. The welded blank assembly of claim 7, wherein the keyhole weld contributes to a lap portion of the hybrid weld joint, the conduction weld contributes to a butt portion of the hybrid weld joint, and the hybrid weld joint is formed using a focused laser and a defocused laser.

9. The welded blank assembly of claim 7, wherein the conduction weld is wider than the keyhole weld and the keyhole weld is deeper than the conduction weld.

10. The welded blank assembly of claim 7, wherein the hybrid weld joint includes an overlapped weld joint section where the keyhole weld and the conduction weld overlap one another in the end of the second sheet metal piece.

11. The welded blank assembly of claim 1, wherein at least one of the first or second sheet metal pieces is made of aluminum or an aluminum-based alloy, the first and second sheet metal pieces have a dissimilar gauge, a surface of the first sheet metal piece is stepped with respect to a surface of the second sheet metal piece at a stepped side of the welded blank assembly, and the hybrid weld joint extends from the stepped side into the welded blank assembly.

12. The welded blank assembly of claim 11, wherein the hybrid weld joint includes a conduction weld that extends from the stepped side into the welded blank assembly at a non-90° angle such that it penetrates into the reduced thickness portion of the first sheet metal piece, crosses a lap interface formed by opposing horizontal surfaces of the first and second sheet metal pieces, crosses a butt interface formed by opposing vertical surfaces of the first and second sheet metal pieces, and at least partially extends into the end of the second sheet metal piece.

13. The welded blank assembly of claim 12, wherein the conduction weld contributes to both a lap portion and a butt portion of the hybrid weld joint and the hybrid weld joint is formed using a single laser.

14. The welded blank assembly of claim 11, wherein the hybrid weld joint includes a weld that extends from the stepped side into the welded blank assembly such that it penetrates all the way through the reduced thickness portion of the first sheet metal piece, crosses a lap interface formed by opposing horizontal surfaces of the first and second sheet metal pieces, and at least partially extends into the end of the second sheet metal piece.

15. The welded blank assembly of claim 14, wherein the weld contributes to both a lap portion and a butt portion of the hybrid weld joint and the hybrid weld joint is formed using a single laser.

16. The welded blank assembly of claim 14, wherein the hybrid weld joint further includes an additional weld that extends from the stepped side into the welded blank assembly such that it spans a butt interface formed by opposing vertical surfaces of the first and second sheet metal pieces and at least partially extends into the end of the second sheet metal piece.

17. The welded blank assembly of claim 16, wherein the weld contributes to a lap portion of the hybrid weld joint and is formed using a defocused laser, the additional weld contributes to a butt portion of the hybrid weld joint and is formed using a focused laser, and the weld is wider than the additional weld and the additional weld is deeper than the weld.

18. The welded blank assembly of claim 16, wherein the hybrid weld joint includes an overlapped weld joint section where the weld and the additional weld overlap one another in the end of the first sheet metal piece.

19. The welded blank assembly of claim 1, wherein the hybrid weld joint has an overall length that is a sum of a length of a lap interface of the lap portion and a length of a butt interface of the butt portion and is between 3 mm to 6.5 mm, inclusive.

20. The welded blank assembly of claim 1, wherein at least one of the first or second sheet metal pieces is made of aluminum or an aluminum-based alloy, the first and second sheet metal pieces have a similar gauge, and the second sheet metal piece also has an end with a reduced thickness portion and a recess that complement the first sheet metal piece reduced thickness portion and recess so that the ends of the first and second sheet metal pieces can nest within each other.

21. The welded blank assembly of claim 20, wherein the hybrid weld joint includes a lap portion that extends across a lap interface formed by opposing horizontal surfaces of the first and second sheet metal pieces, a first butt portion that extends across a first butt interface formed by opposing first vertical surfaces of the first and second sheet metal pieces, and a second butt portion that extends across a second butt interface formed by opposing second vertical surfaces of the first and second sheet metal pieces.

22. The welded blank assembly of claim 1, wherein at least one of the first or second sheet metal pieces is made of aluminum or an aluminum-based alloy, the first and second sheet metal pieces have a dissimilar gauge, and the first and second sheet metal pieces have tapered edges that form a butt interface.

23. A method of making a welded blank assembly, comprising the steps of:
providing a first sheet metal piece having an end with a reduced thickness portion and a recess;
providing a second sheet metal piece having an end, wherein the first sheet metal piece, the second sheet metal piece, or both the first and second sheet metal pieces is made of aluminum or an aluminum-based alloy;
arranging the first and second sheet metal pieces so that the second sheet metal piece end nests within the first sheet metal piece recess; and
using a laser to form a hybrid weld joint between the first and second sheet metal pieces, wherein the hybrid weld joint includes both a lap portion and a butt portion.
